(19) United States
(12) Patent Application Publication
(10) Pub. No.: US 2003/0220073 A1
(43) Pub. Date: Nov. 27, 2003

(54) Safe cellphone

(76) Inventor: Thomas G. Packard, Edmonds, WA (US)

Correspondence Address: THOMAS PACKARD, 7005 150TH PI. SW., EDMONDS, WA, 98026, US

(21) Appl. No.: 10/441,529

(22) Filed: May 19, 2003

Related U.S. Application Data
(60) Provisional application No. 60/382,223, filed on May 21, 2002.

(51) Int. Cl. H04B 3/36; H04B 7/14

(52) U.S. Cl. 455/7; 455/9

(57) ABSTRACT

A cellphone or computer or video camera, etc. id constructed/designed to radiate less harmful/interfering/damaging electromagnetic energy to the immediate user or environment by the use of removeable, and thus remoteable, relay transceivers that would emit most of the signal radiant energy distant from the immediate user or environment.

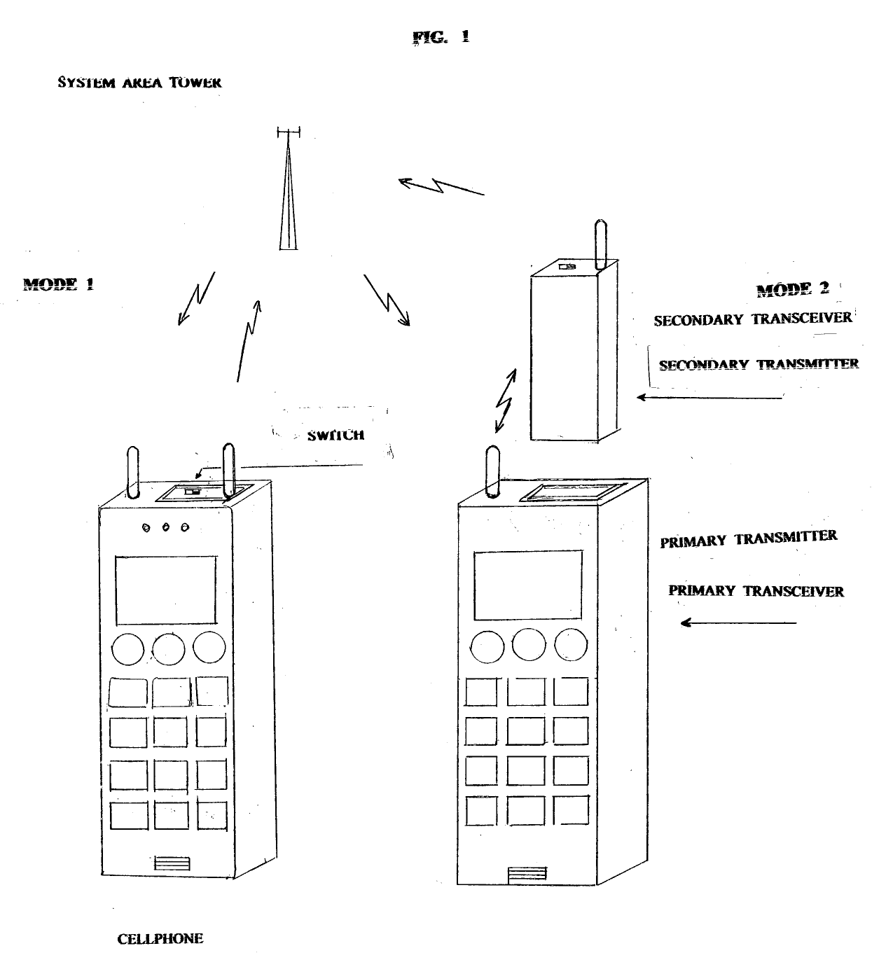

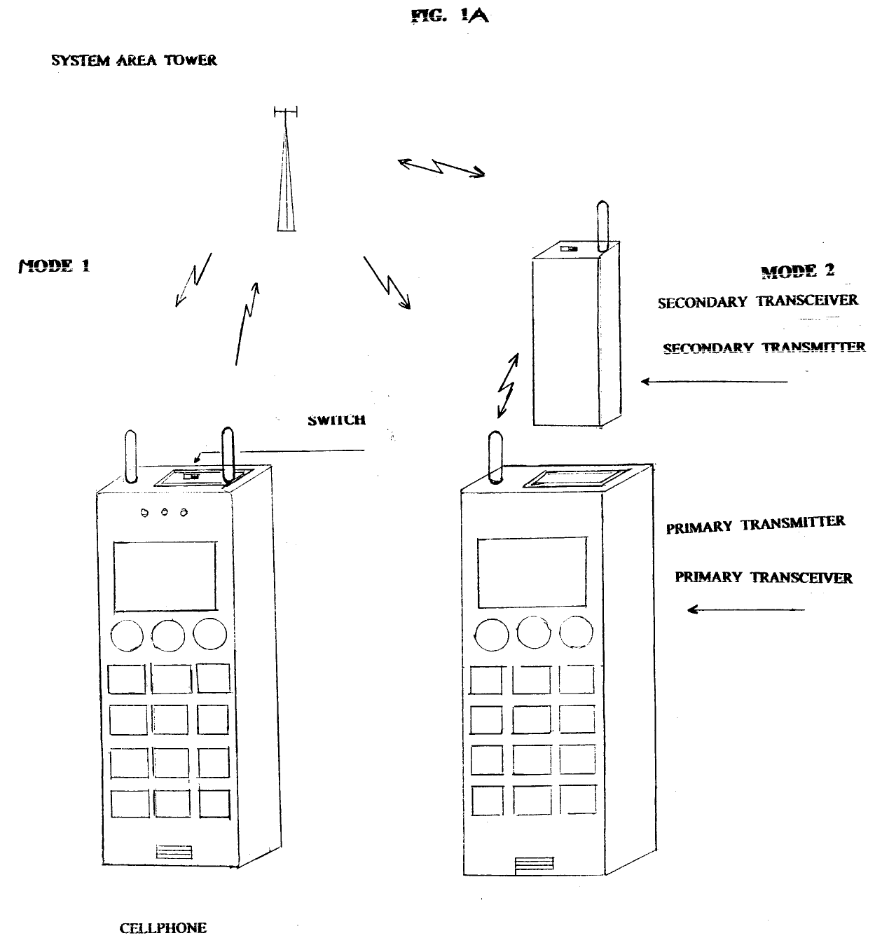

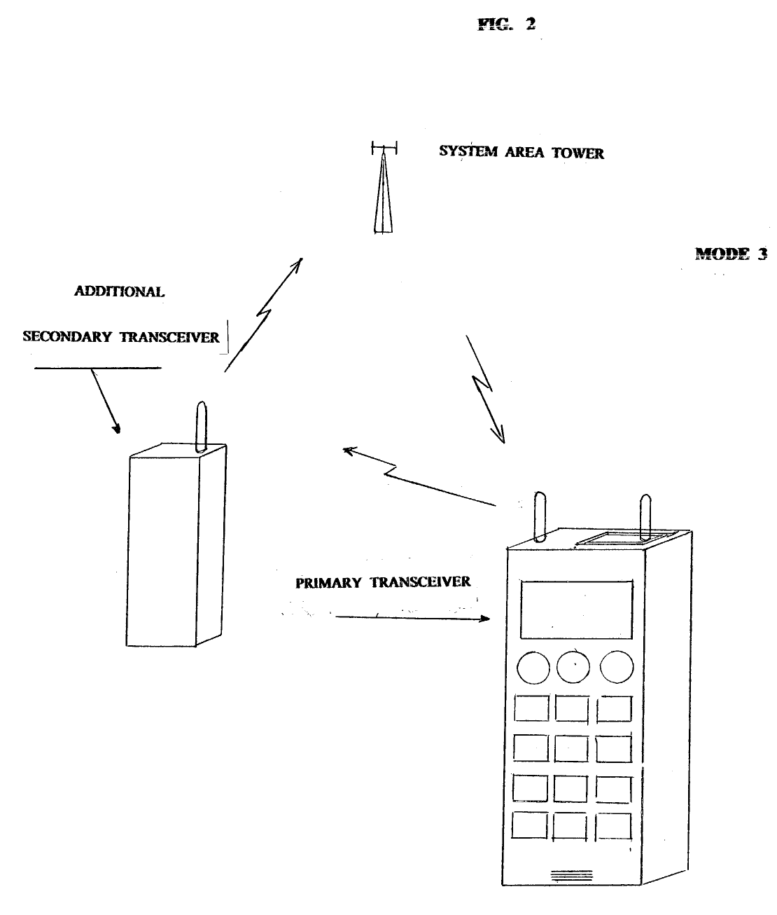

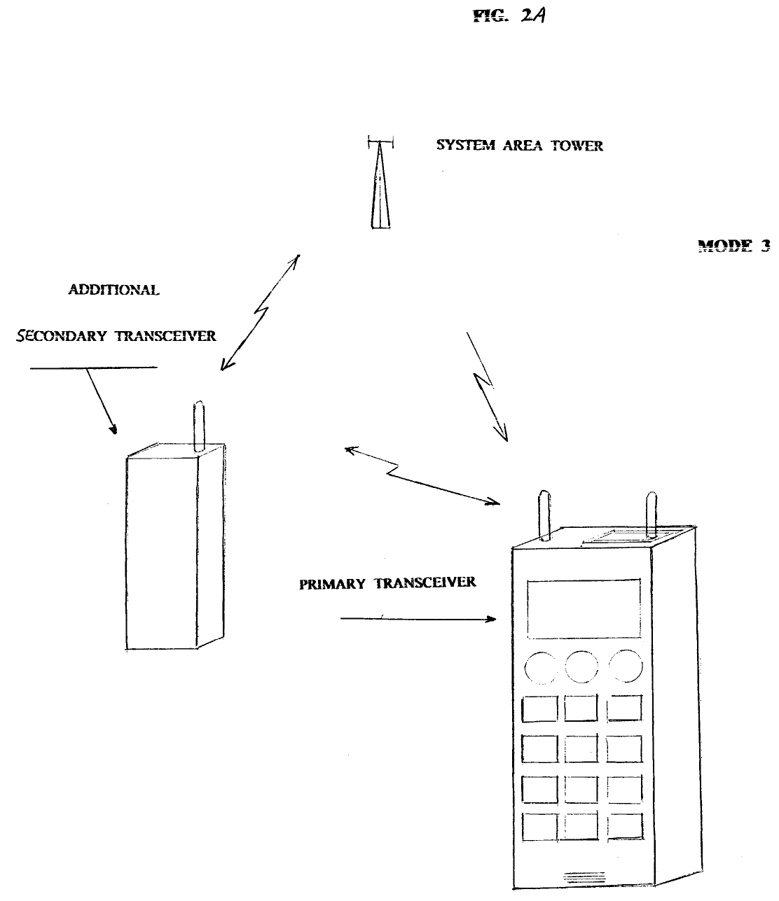

### BACKROUND OF THE INVENTION

Cellphones and some computers, etc. emit high frequency electromagnetic radiation in very close proximity to sensitive biological cells, tissue and organs. This is certainly not benifical and may be harmful to a person. The disclosed invention is a cellphone/computer, etc. that enables a concerned person to minimize/reduce radiation exposure during use, if so desired. Also there may be other environmental situations where cellphone/computer radiation output is a concern and may be reduced, such as on airliners, in hospitals, etc.

### BRIEF SUMMARY OF THE INVENTION

The cellphone or computer, etc. is constructed with at least two transceivers a primary and a secondary. The primary will be a relatively very low power output transmitter and the secondary will be the relatively high power output transmitter. The secondary will have at least the normal cellphone transmitter output power and will transmit to the remote cellphone/telephone system area receiver station/tower at the required variable power output. The secondary transmitter will be also removerable from the main cellphone/computer body if so desired. The cellphone/computer may be used in the common conventional manner or mode and when used this way the primary would not radiate a transmission to the secondary. When the cellphone/computer is operated in the safe mode/manner the secondary transceiver may be removed, and separated from the main cellphone/computer body and at a distance acting as a remote relay transmitter to the distant area system cellphone/telephone tower/link facility station. The secondary transceiver may receive from the remote facility station, if necessary, as well as the primary transceiver. The primary transceiver will be able to receive directly from the distant system facility station but will be designed to transmit to the secondary transceiver when the secondary is in a remote status or mode. The cellphone/computer may also be designed to operate with or through more than one secondary and in this scenerio the cellphone/computer contained secondary transceiver would be switched off and the primary would transmit to the system area facility through the remote alternate secondary.

Thus in these various manners the user can effectively minimize exposure to most of the cellphone/computer transmitter radiation energy intensity, if desired.

### DETAILED DESCRIPTION

The cellphone or computer or will be designed with at least two transeivers. A primary, that will contain a relatively low power output transmitter, which will be constructed into the cellphone/computer body, and a secondary transceiver which will contain a relatively high power output transmitter, as in a normal cellphone the secondary will be contained within or attached to the cellphone/computer body but will be removeable from the cellphone/computer body if so desired. Each transeiver will have its own associated antenna, batteries and signal processing electronics. When the cellphone/computer is operating in the normal/common (unsafe) mode the primary transeiver transmitter will not be required to transmit an external signal. When the cellphone/computer is operating in the safe mode and the secondary transceiver is not being supplanted by another remote secondary transceiver somewhere else, the contained/attached secondary will be removed from the cellphone/computer body a distance of inches to over 100 feet. When making a call in this safe mode. The primary tramsmitter will send low power transmissions to the removed and remote secondary which will amplify the received low power signal transmissions and relay/retransmit these signal transmissions at much higher strength to the distant area cellphone/telephone system facility. Transmissions from the area system facility will be received directly by the primary cellphone/computer transceiver or, perhaps by the secondary and relayed back to the primary at low power as needed. The cellphone/computer can also function in the safe mode with the secondary transeiver in place in the cell phone through an alternate remote, identical or similar, secondary transceiver and in this case the cellphone/computer contained/attached secondary would be switched off and not function. The cellphone/computer and associated transceivers would be designed to operate in various signal types, analog, digital, etc. the power output of the contained cellphone/computer primary transmitter will be relatively very weak and the output frequency will also be designed to minimize damaging biological effects or other effects if necessary thus the primary transmitter damaging radiation or harmful energy output effects will be relatively insignificient as a health or environmental concern. This manner of safe personal signal transmission would also be applicable to graphic, video data for cellphones, computers, cameras, etc.

I claim:

1. A cellphone containing two transmitter/receivers (transceivers) a primary and a secondary.

2. The cellphone of claim 1, wherein:
the primary will have a relatively low power output. Transmitter and the secondary will have a relatively high power output transmitter.

3. The cellphone of claim 1, wherein:
the secondary transmitter receiver will be removeable from the cellphone.

4. The cellphone of claim 1, wherein:
the primary will be able transmitt to the secondary at low relative power output.

5. The cellphone of claim 1, wherein:
the secondary will transmitt at high relative power output to the area telephone system tower facility.

6. The cellphone of claim 1, wherein:
the secondary will transmit at low relative power output to the primary if necessary.

7. The cellphone of claim 1, wherein:
the secondary will receive from the area telephone system tower facility if necessary.

8. The cellphone of claim 1, wherein:
the primary will receive from the area telephone system tower facility.

9. The cellphone of claim 1, wherein:
the primary will receive from the secondary if necessary.

10. The cellphone of claim 1, wherein:
the primary will be able to transmit to and receive from an alternate secondary if necessary.

11. The cellphone of claim 1, wherein:
the alternate secondary would be able to function as the secondary.

12. The cellphone of claim 1, wherein each transceiver will have a battery, an antenna and associated required processing electronics.

13. A cellphone having a primary transceiver (transmitter and receiver) and one or more secondary transceivers and the energy output of the primary will be much less than the secondary and the frequency output of the primary may be different from the secondary.

14. The cellphone of claim 13, wherein:
the cellphone may also send and receive video pictures or graphics.

15. A computer or camera having a primary transceiver transmitter and receiver) and one or more secondary transceivers.

16. The computer or camera of claim 15, wherein:
each transceiver will have a battery, an antenna, and required processing electronics.

17. The computer or camera of claim 15, wherein:
the primary transmitter will have a very low energy output as compared to secondary transmitter and there frequencies may be different.

18. The camera of claim 15, wherein:
there may or may not be a primary receiver.
